(19) United States
(12) Patent Application Publication
(10) Pub. No.: US 2004/0107265 A1
(43) Pub. Date: Jun. 3, 2004

(54) Shared memory data transfer apparatus

(75) Inventor: Kouta Yasunaga, Kanagawa (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD

(21) Appl. No.: 10/692,716

(22) Filed: Oct. 27, 2003

(30) Foreign Application Priority Data
Nov. 19, 2002 (JP) P. 2002-335332

(51) Int. Cl. G06F 15/167; G06F 15/16; G06F 13/28; G06F 12/14

(52) U.S. Cl. 709/213; 709/208; 711/130

(57) ABSTRACT

Providing shared memory data transfer apparatus which enables data transfers between a plurality of bus masters and a shared memory by using a simple, small-scale control circuit

In order to solve the problem, the shared memory data transfer apparatus includes a plurality of master I/Fs respectively connected to the masters, write data buffers connected to the master I/Fs for retaining data written from the masters to the shared memory, read data buffers connected the master interfaces for retaining data read from the shared memory to the masters, a command FIFO provided between the master interfaces and the shared memory for storing commands from the masters directed to the shared memory in a first-in, first-out fashion, and a shared memory I/F for controlling data transfers from the write buffers to the shared memory or data transfers from the shared memory to the read buffers in accordance with commands fetched from the command FIFO.

### BACKGROUND OF THE INVENTION

1. Field of the Invention

The present invention relates to shared memory data transfer apparatus where a plurality of masters access one shared memory to perform data transfers.

2. Description of the Related Art

In recent years, in a system LSI where a plurality of bus masters such as processors, DSPs and DMAs and bus slaves such as memories and peripheral I/O devices are interconnected via a plurality of buses, it is important to be able to perform efficient processing. To this end, it is important to share a bus slave and enable efficient access control with small circuit footprint and low power consumption.

An example of a related art technology to control accesses from multiple bus masters to a shared resource is “A data transfer system and data transfer apparatus” described in Japanese Patent Laid-Open No. 93274/1995. This approach enables high-speed data transfers by providing a data buffer and a data transfer control circuit corresponding to each bus master and accessing a shared memory or another data buffer by way of the data transfer control circuit.

The related art technology has a problem that the circuit scale is large because the data transfer control circuit is a complicated circuit which requires an address buffer and a large number of control circuits.

### SUMMARY OF THE INVENTION

The invention has been accomplished to solve the problem and aims at providing shared memory data transfer apparatus which enables data transfers between a plurality of bus masters and a shared memory by using a simple, small-scale control circuit.

In order to attain the object, shared memory data transfer apparatus according to a first aspect of the invention is shared memory data transfer apparatus where a plurality of masters (master 1, 5, 9, 13) access one shared memory (shared memory 20) to perform data transfers, the shared memory data transfer apparatus comprising a plurality of master interfaces (master I/Fs 2, 6, 10, 14) respectively connected to the master interfaces, write butters (write data buffers 3, 7, 11, 15) connected to the master interfaces for retaining data written from the masters to the shared memory, read butters (read data buffers 4, 8, 12, 16) connected to the master interfaces for retaining data read from the shared memory to the masters, a FIFO (command FIFO 18) provided between the master interfaces and the shared memory for storing commands from the masters directed to the shared memory in a first-in, first-out fashion, and a shared memory interface (shared memory I/F 19) for controlling data transfers from the write buffers to the shared memory or data transfers from the shared memory to the read buffers in accordance with commands fetched from the FIFO.

According to the configuration, by storing commands from the masters into a FIFO in a first-in, first-out fashion then fetching the commands from the FIFO in a first-in, first-out fashion and executing data transfers to a shared memory, it is possible to perform data transfers between a plurality of bus master and the shared memory by way of a simple, small-scale control circuit (FIFO).

Shared memory data transfer apparatus according to a second aspect of the invention is shared memory access apparatus according to the first aspect of the invention, comprising an arbiter for storing a plurality of simultaneously issued commands into the FIFO in a predetermined order.

Shared memory data transfer apparatus according to a second aspect of the invention is shared memory access apparatus according to the first or second aspect of the invention, comprising an arbiter for referencing the command contents and rearranging the order of commands to be stored into the FIFO.

According to the configuration, it is possible to rearrange the order of commands from the masters by using an arbiter. This efficiently reads data from a shared memory.

Shared memory data transfer apparatus according to a fourth aspect of the invention is shared memory data transfer apparatus according to any one of the first through third aspects of the invention, which issues commands to be stored into the FIFO per access to the shared memory.

Shared memory data transfer apparatus according to a fifth aspect of the invention is shared memory data transfer apparatus according to any one of the first through fourth aspects of the invention, which uses a fixed burst length in an access to the shared memory.

According to the configuration, by controlling issuance of command to be stored into the FIFO and access to the shared memory, it is possible to perform efficient data transfer control over a shared memory interface.

### BRIEF DESCRIPTION OF THE DRAWINGS

FIG. 1 is a block diagram showing a configuration of shared memory data transfer apparatus according to a first embodiment of the invention;

FIG. 2 is a sequence diagram explaining the data transfer operation of the shared memory data transfer apparatus shown in FIG. 1; and

FIG. 3 is a block diagram showing a configuration of shared memory data transfer apparatus according to a second embodiment of the invention.

### DESCRIPTION OF THE PREFERRED EMBODIMENTS

Embodiments of the invention will be described referring to drawings.

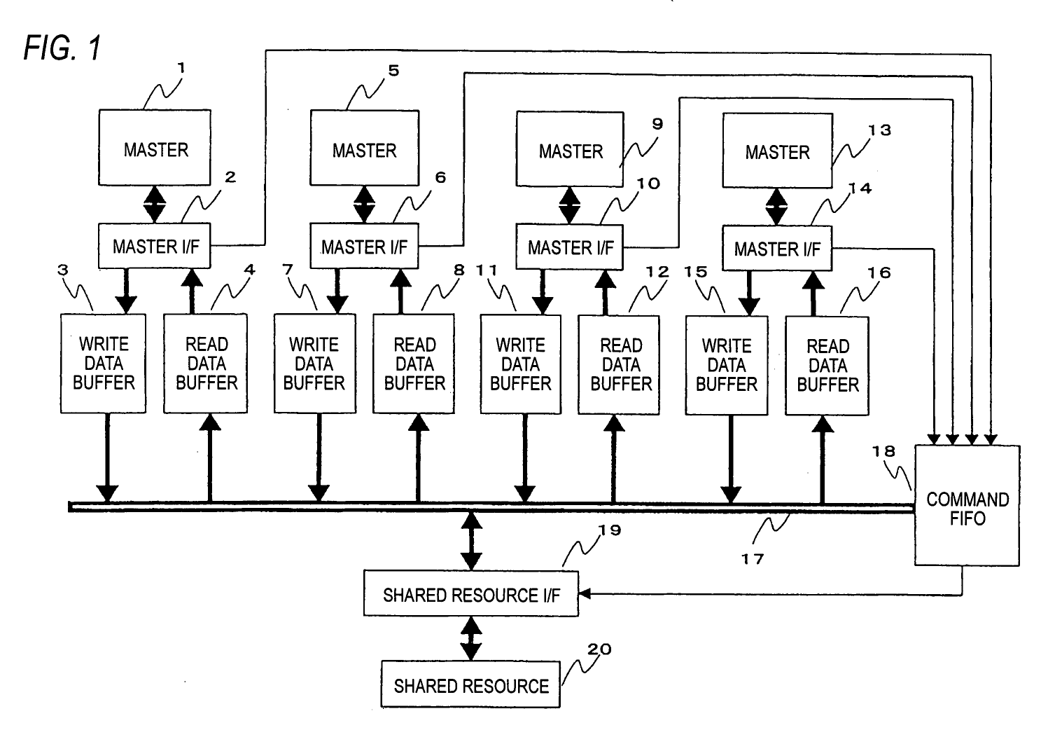

FIG. 1 is a block diagram showing a configuration of shared memory data transfer apparatus according to a first embodiment of the invention. As shown in FIG. 1, in the data transfer apparatus, a processor, a bus master (hereinafter referred to as a master) 1, a master 5, a master 9, and a master 13 such as a DSP and a DMP access a shared memory 20 to perform data read and write operations.

The master 1 is connected to a write data buffer 3 and a read data buffer 4 via a master interface (I/F) 2. The master 5 is connected to a write data buffer 7 and a read data buffer 8 via a master interface (I/F) 6. The master 9 is connected to a write data buffer 11 and a read data buffer 12 via a master interface (I/F) 10. The master 13 is connected to a write data buffer 15 and a read data buffer 16 via a master interface (I/F) 14.

A command FIFO 18, a shared memory interface (shared memory I/F) 19, the read data buffers 3, 7, 11, 15 and read data buffers 4, 8, 12, 16 are interconnected via a data bus 17. A shared memory interface 19 is connected to the shared memory 20. The command FIFO 18 is connected to master interfaces (master I/Fs) 2, 6, 10, 14 and the shared memory I/F 19 via a control line.

Assume that the bus width of the shared memory 20 is 16 bits and an 8-bit burst fixed access is made to the shared memory 20 in order to simplify the control circuit of the shared memory I/F 19. Assume also that the masters 1, 5, 9, 13 operate in accordance with the AMBA AHB protocol of the ARM Corporation.

Transfer sizes of 8, 16 and 32 bits are supported. Burst types including the individual transfer, undefined length incremental burst transfer, 4-, 8- or 16-beat incremental burst transfer and 4-, 8- or 16-beat wrap transfer are supported.

A write data buffer connected to each master I/F has a capacity of 64 bytes in order to support 32-bit, 16-beat wrap transfers. A read data buffer connected to each master I/F has a capacity of 64 bytes in order to support 32-bit, 16-beat wrap transfers. The command FIFO 18 has a capacity to store as many commands as the number of masters (5 in the example shown). A command stored into the command FIFO 18 comprises information including a burst start address, write transfer or read transfer, wrap burst or incremental burst, transfer size, beat count and a master ID.

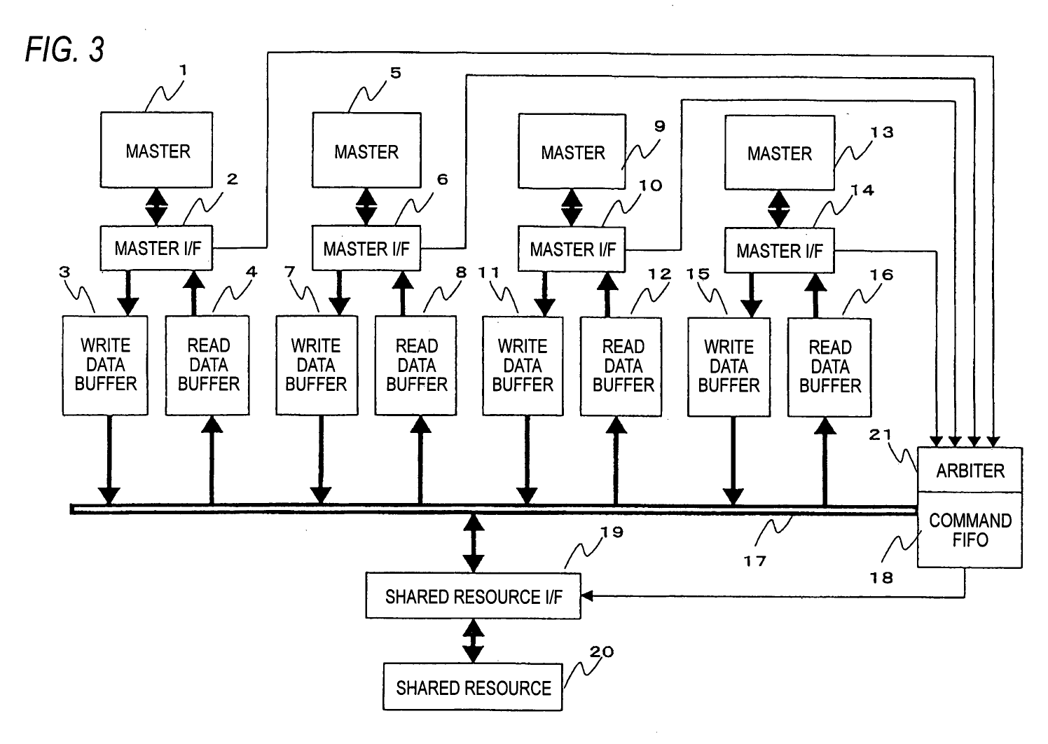

Operation of the shared memory access apparatus of the aforementioned configuration will be described. In the above configuration, the master I/F 2 judges and responds to a request coming from the master 1 in accordance with the protocol of the data bus 17. When making a request, the master 1 passes the details of the request as a command to the command FIFO 18. In case the master 1 performs a write transfer to the shared memory 20, the master I/F 2 starts the data transfer in case the buffer 3 is empty. In the case of a read transfer, the master I/F 2 reads out the read data from the shared memory 20 via the read data buffer 4. Once the master I/F 2 has written data, the write data buffer 3 disables data write until the shared memory I/F reads data. The read data buffer 4 stores the read data from the master I/F 2. It is possible to support a wait request and a wrap transfer even when transfer size differs between transfers, by storing data into the read data buffer 4. The command FIFO 18 sequentially retains commands from the master I/Fs, and sequentially passes the stored commands to the shared memory I/F 19. At the same time, it is possible to add an arbiter (see FIG. 3) for arbitrating between a plurality of simultaneously issued commands. The shared memory I/F 19 converts commands output by the master I/F 2 to a command format conforming to the protocol of the shared memory protocol and fetches commands from the command FIFO 18 per transfer unit of the shared memory 20. The same operation as the master 1 system is made for another master system.

When performing data write into the shared memory 20 by way of an incremental burst transfer, the master 1 writes data into a free space of the write data buffer 3 via the master I/F 2. When performing a data transfer exceeding 8 bytes, the master 1 sends a command from the master I/F 2 to the command FIFO 18.

In case there remains no free space in the write data buffer 3 or command FIFO 18, the master I/F 2 returns a wait signal to the master 1 and discontinue the transfer. That is, for data write in an incremental burst transfer, the master 1 can perform a data transfer to the shared memory 20 irrespective of the transfer state of other masters, as long as there remain a free space of 16 bytes or more in the write data buffer 3 of the master 1 and a free space in the command FIFO 18.

The shared memory I/F 19 fetches commands in a first-in, first-out fashion from the command FIFO 18 each time a burst transfer to the shared memory 20 takes place. An 8-bit burst transfer from the start address specified in the command is a burst size supported by a single command. When performing an 8-burst transfer, the shared memory I/F 19 fetches the data from the write data buffer 3 and transfers the data to the shared memory 20. The shared memory I/F 19 outputs a mask signal to the shared memory 20 to perform transfer of a desired amount of data in case a single command length is less than 16 bytes.

When the master 1 performs data write into the shared memory 20 by way of a wrap burst transfer, the master I/F 2 gives data write permission in case there remains a free space of the transfer size in the write data buffer 3. A command is sent to the command FIFO 18 in a single transfer irrespective of the transfer size.

Data is stored into the write data buffer 3 in accordance with the addresses of wrap burst transfers. In case 32-bit wrap burst transfers are performed to the addresses 44, 48, 4C, 40, the data is written into each address 4, 8, C, 0 of the write data buffer 3.

Receiving a wrap burst transfer command in a first-in, first-out fashion from the command FIFO 18, the shared memory I/F 19 assumes a burst start address as a boundary of a wrap transfer. In the above-mentioned transfer, the burst start address is 40. Write data from the write data buffer 3 is read starting with address 0 of the read data buffer 3.

When performing data read operation from the shared memory 20 by way of an incremental burst transfer, the master I/F 2 sends a command in units of 8 bytes to the command FIFO 18.

When the shared memory I/F 19 has received a read command from the command FIFO 18 and has read data from the shared memory 20, the shared memory I/F 19 stores the read data into the read data buffer 4. Once the data is stored into the read data buffer 4, the master I/F 2 reads the data and transfers the data to the master 1.

When the master 1 performs data read operation from the shared memory 20 by way of a wrap burst transfer, the master I/F 2 sends one command to the command FIFO 18 in a single data transfer irrespective of the transfer size.

Receiving a wrap burst transfer command in a first-in, first-out fashion from the command FIFO 18, the shared memory I/F 19 assumes a burst start address as a boundary of a wrap transfer. Same as the incremental burst transfer, the shared memory I/F 19 writes the data read from the shared memory 20 into the read data buffer 4. The master I/F 2 reads data from the address of the read data buffer 4 corresponding to the address of the wrap transfer, and transfers the data to the master 1.

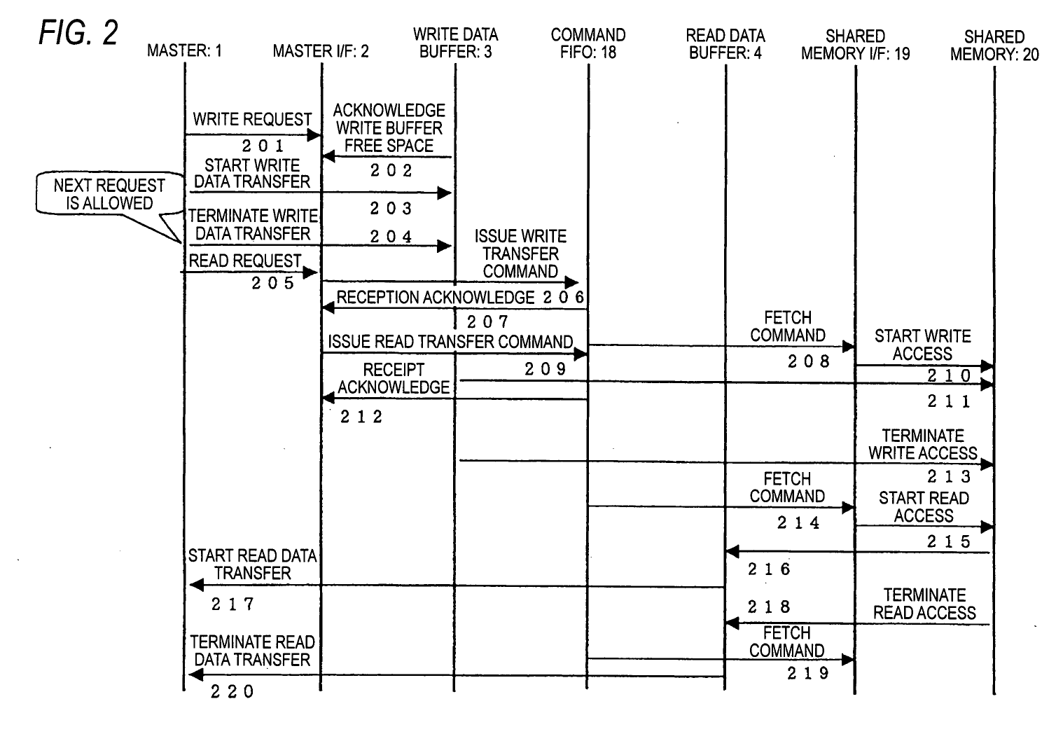

FIG. 2 is a sequence diagram explaining the data transfer operation. The master 1 issues a request to write data into the shared memory 20 to the master I/F 2 in step 201. In step 202, the master I/F 2 receives a free space acknowledgment from the write data buffer 3. In step 203, the master I/F 2 starts a data transfer to the write data buffer 3 from the master 1. In step 204, the master I/F 2 terminates the data transfer to the write data buffer 3.

The master 1 issues a request to read data from the shared memory 20 to the master I/F 2 in step 205.

In step S206, the master I/F 2 issues a write transfer command to the command FIFO 18. In response to this command, the command FIFO 18 makes a receipt acknowledgment to the master I/F 2 in step 207.

The shared memory I/F 19 fetches a command in a first-in, first-out fashion from the command FIFO 18 in step 208. In this practice, the shared memory I/F 19 fetches the write transfer command issued from the master I/F 2. The shared memory I/F 19 starts a data write access to the shared memory 20 in step 210. The data is transferred to the shared memory 20 from the write data buffer 3 in step 211.

Meanwhile, the master I/F 2 issues a data read transfer command to the command FIFO 18 in step 209. In response to this command, the command FIFO 18 makes a receipt acknowledgment to the master I/F 2 in step 212.

In step 213, the data from the write data buffer 3 is written into the shared memory 20.

The shared memory I/F 19 fetches a command in a first-in, first-out fashion from the command FIFO 18 in step 214. In this practice, the shared memory I/F 19 fetches the read transfer command issued from the master I/F 2. The shared memory I/F 19 starts a data read access to the shared memory 20 in step 215. The data is read from the shared memory 20 and written into the read data buffer 4 in step 216.

In step 217, transfer of the read data from the read data buffer 4 to the master 1 is started. In step 218, a data read access to the read data buffer 4 from the shared memory 20 is complete. In step 220, transfer of read data from the read data buffer 4 to the master 1 is complete. Meanwhile, the shared memory I/F 19 fetches another command from the command FIFO 18 in a first-in, first-out fashion in step 219.

Data transfer to the shared memory 20 of the masters 5, 9, 13 is the same as that for the master 1.

According to this embodiment, data write/read commands to the shared memory 20 of the masters 1, 5, 9, 13 are stored into the command FIFO 18 in a first-in, first-out fashion. The stored commands are read via the shared memory I/F 19 in a first-in, first-out fashion, and data write/read to/from the shared memory 20 is executed. As a result, even when data transfers by the masters 1, 5, 9, 13 are asynchronous, the commands can be read via the shared memory I/F 19 and executed in order without causing the problem of collision. In this way, by using the command FIFO 18 as a data transfer control circuit, it is possible to simplify the circuit configuration of the data transfer control circuit thus downsizing the circuit scale.

Even in case a plurality of access signals such as write requests and read requests make accesses in an asynchronous fashion, commands are stored into the command FIFO 18 in the order they were issued then fetched and executed in the order they were issued. This makes it possible to perform smooth data transfers without changing the access means for the shared memory 20.

FIG. 3 is a block diagram showing a configuration of shared memory data transfer apparatus according to a second embodiment of the invention. The same sections as FIG. 1 are given the same signs for ease of description. In the data transfer apparatus, commands from a plurality of master I/Fs 2, 6, 10, 14 are stored into the command FIFO 18 via an arbiter 21.

The arbiter 21, receiving a read transfer command, references the address of a write transfer command stored in a command FIFO. In case the address to be read is an address not being accessed by another master in a write transfer, the arbiter 21 places the read transfer command before the write transfer command to change the command order and stores the read transfer command in a command FIFO 18. The shared memory I/F 19 fetches and executes the read transfer command prior to the write transfer command. This accelerates a data read acknowledgment from the shared memory 20.

As mentioned hereinabove, according to the invention, when a plurality of masters attempt to access a single shared memory to perform data transfers, commands from the masters are stored into a FIFO, then the commands are fetched in a first-in, first-out fashion to execute data transfers to the shared memory. This enables data transfers between a plurality of bus masters and a shared memory by using a simple, small-scale control circuit (FIFO). Even in case a plurality of access signals such as write requests and read requests make accesses in an asynchronous fashion, commands are stored into the control circuit (FIFO) in the order they were issued then fetched and executed in the order they were issued. This makes it possible to perform smooth data transfers without changing the access means for the shared memory.

What is claimed is:

1. Shared memory data transfer apparatus where a plurality of masters access one shared memory to perform data transfers, said shared memory data transfer apparatus comprising:
a plurality of master interfaces respectively connected to the master interfaces,
write butters connected to the master interfaces for retaining data written from said masters to said shared memory,
read butters connected to the master interfaces for retaining data read from said shared memory to said masters,
a FIFO provided between said master interfaces and said shared memory for storing commands from the masters directed to said shared memory in a first-in, first-out fashion, and
a shared memory interface for controlling data transfers from said write buffers to said shared memory or data transfers from said shared memory to said read buffers in accordance with commands fetched from said FIFO.

2. Shared memory access apparatus according to claim 1, comprising an arbiter for storing a plurality of simultaneously issued commands into said FIFO in a predetermined order.

3. Shared memory access apparatus according to claim 1 or 2, comprising an arbiter for referencing the command contents and rearranging the order of commands to be stored into said FIFO.

4. Shared memory data transfer apparatus according to any one of claims 1 through 3, which issues commands to be stored into said FIFO per access to said shared memory.

5. Shared memory data transfer apparatus according to any one of claims 1 through 4, which uses a fixed burst length in an access to said shared memory.
